(19) United States
(12) Patent Application Publication
(10) Pub. No.: US 2026/0152008 A1
(43) Pub. Date: Jun. 4, 2026

(54) INKJET RECORDING SYSTEM AND INKJET RECORDING METHOD

(71) Applicant: KYOCERA CORPORATION, Kyoto-shi, Kyoto (JP)

(72) Inventor: Toshiaki MUTSUO, Hannan-shi, Osaka (JP)

(21) Appl. No.: 19/123,071

(22) PCT Filed: Jan. 18, 2024
(86) PCT No.: PCT/JP2024/001358

§ 371 Date: Apr. 22, 2025

(30) Foreign Application Priority Data
Jan. 26, 2023 (JP) 2023-010266

(51) Int. Cl. B41J 2/145; B41J 2/175

(52) U.S. Cl. CPC B41J 2/2114; B41J 2/2132; B41J 3/4078; B41J 11/0015

(57) ABSTRACT

A computer generates ink dot data indicating a pattern of ink dots used for ejection of ink from an ink head and treatment liquid dot data indicating a pattern of treatment liquid dots used for ejection of a treatment liquid from a treatment liquid head. The computer generates the treatment liquid dot data by performing a reduction process and an extension process. The reduction process is a process of converting the ink dot data at a first resolution to data of a primary dot pattern at a second resolution being lower than the first resolution. The extension process is a process of converting the data of the primary dot pattern to data of a secondary dot pattern by extending each of dots in the primary dot pattern.

### TECHNICAL FIELD

The present invention relates to an inkjet recording system and an inkjet recording method.

### BACKGROUND OF INVENTION

Patent Literature 1 describes an inkjet textile printing system including an inkjet printer to record an image on a recording material made of fabric. In the inkjet textile printing system, data of the pattern of ink dots is generated based on image data of an image to be recorded on the recording material to control the ejection of ink from an ink ejection head. In this system, data of the pattern of pretreatment agent dots is also generated based on the data of the pattern of ink dots to control the ejection of the pretreatment agent from a pretreatment agent head.

### CITATION LIST

### Patent Literature

Patent Literature 1: Japanese Unexamined Patent Application Publication No. 2005-232633

### SUMMARY

In one aspect of the present invention, an inkjet recording system includes an inkjet head, an ink data generator, a treatment-liquid data generator, and a controller. The inkjet head includes an ink head that ejects ink onto a recording material and a treatment liquid head that ejects a treatment liquid to come in contact with the ink on the recording material. The ink data generator generates ink dot data based on image data of an image to be recorded on the recording material. The ink dot data indicates a pattern of ink dots to be formed on the recording material with the ink ejected from the ink head. The treatment-liquid data generator generates treatment liquid dot data indicating a pattern of treatment liquid dots to be formed on the recording material with the treatment liquid ejected from the treatment liquid head. The controller controls the inkjet head to cause the ink head to eject the ink based on the ink dot data and to cause the treatment liquid head to eject the treatment liquid based on the treatment liquid dot data. The treatment-liquid data generator generates the treatment liquid dot data by performing a reduction process and an extension process. The reduction process is a process of converting the ink dot data at a first resolution to data of a primary dot pattern at a second resolution being lower than the first resolution. The extension process is a process of converting the data of the primary dot pattern to data of a secondary dot pattern by extending each of dots in the primary dot pattern. In the above aspect of the present invention, the inkjet recording system can shorten the processing time for generating the dot pattern data corresponding to the image to be recorded on the recording material.

In another aspect of the present invention, an inkjet recording method is a method for recording an image on a recording material using an inkjet head including an ink head that ejects ink onto a recording material and a treatment liquid head that ejects a treatment liquid to come in contact with the ink on the recording material. The method includes generating ink dot data, generating treatment liquid dot data, causing the ink head to eject the ink, and causing the treatment liquid head to eject the treatment liquid. Generating the ink dot data includes generating the ink dot data based on image data of the image to be recorded on the recording material. The ink dot data indicates a pattern of ink dots to be formed on the recording material with the ink ejected from the ink head. Generating the treatment liquid dot data includes generating the treatment liquid dot data indicating a pattern of treatment liquid dots to be formed on the recording material with the treatment liquid ejected from the treatment liquid head. Causing the ink head to eject the ink includes causing the ink head to eject the ink based on the ink dot data. Causing the treatment liquid head to eject the treatment liquid includes causing the treatment liquid head to eject the treatment liquid based on the treatment liquid dot data. Generating the treatment liquid dot data includes performing a reduction process and an extension process. The reduction process is a process of converting the ink dot data at a first resolution to data of a primary dot pattern at a second resolution being lower than the first resolution. The extension process is a process of converting the data of the primary dot pattern to data of a secondary dot pattern by extending each of dots in the primary dot pattern. In the above aspect of the present invention, the inkjet recording method can shorten the processing time for generating the dot pattern data corresponding to the image to be recorded on the recording material.

### BRIEF DESCRIPTION OF THE DRAWINGS

FIG. 1 is a diagram of an inkjet recording system according to an embodiment of the present invention, illustrating its overall structure.

FIG. 2 is a flowchart of an inkjet recording method, showing its procedure.

FIG. 3 is a diagram illustrating an example pattern of ink dots indicated by data of the logical OR of pieces of ink dot data for the respective colors.

FIG. 4 is a diagram of an example pattern of primary dots indicated by primary dot pattern data.

FIG. 5 is a diagram of an example pattern of secondary dots indicated by secondary dot pattern data.

FIG. 6 is a diagram of an example pattern of treatment liquid dots indicated by treatment liquid dot data.

### DESCRIPTION OF EMBODIMENTS

In the inkjet textile printing system described above, the dots of a treatment agent such as a pretreatment agent are to be formed at the ink dots and also around each of the ink dots on a recording material to stably fix the ink on the recording material using the treatment agent. In this case, the technique described in Patent Literature 1 has a high processing load for generating the data of the pattern of treatment agent dots based on the data of the pattern of ink dots. Such a high processing load may cause a long processing time to be taken for generating the dot pattern data corresponding to the image to be recorded on the recording material.

An inkjet recording system and an inkjet recording method are thus awaited to shorten the processing time for generating the dot pattern data corresponding to the image to be recorded on the recording material.

An inkjet recording system according to one or more embodiments of the present invention will now be described with reference to the drawings. In one or more embodiments below, a system including an inkjet printer including an ink head that ejects ink for forming an image onto a wide and long recording material will be described as a specific example of the inkjet recording system. The inkjet printer may be used for digital textile printing to print (record) images such as letters or patterns by inkjet printing on a recording material that is a fabric member made of fabric such as woven fabric or knitted fabric. The inkjet printer included in the inkjet recording system according to one or more embodiments of the present invention may also be used for printing various images on a recording material such as a paper sheet or a resin sheet.

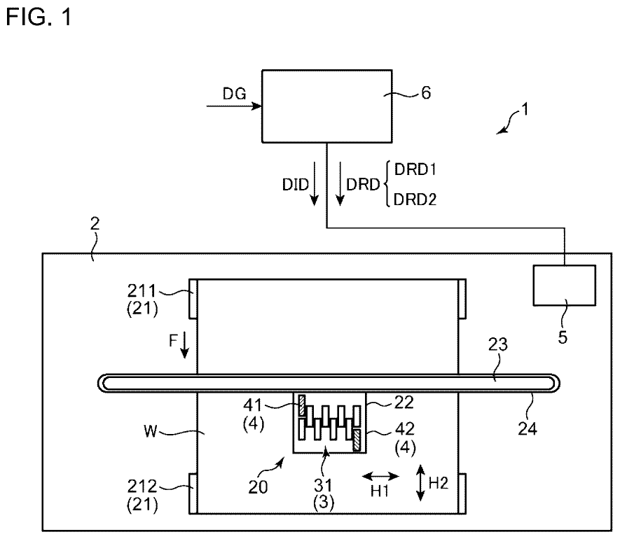

As illustrated in FIG. 1, an inkjet recording system 1 includes an inkjet printer 2 and a computer 6 connected to the inkjet printer 2 to allow data communication with the inkjet printer 2. FIG. 1 schematically illustrates the structure of the inkjet printer 2 as viewed from above. In the inkjet recording system 1, the computer 6 functions as an ink data generator that generates ink dot data DID based on image data DG of an image to be printed on a workpiece W that is a recording material, and also functions as a treatment-liquid data generator that generates treatment liquid dot data DRD. The inkjet printer 2 prints an image on the workpiece W by inkjet printing based on the ink dot data DID and the treatment liquid dot data DRD generated by the computer 6. Note that, in the inkjet recording system 1, the computer 6 may be incorporated in the inkjet printer 2. In other words, the inkjet printer 2 may function as the ink data generator and the treatment-liquid data generator in addition to printing an image on the workpiece W by inkjet printing.

The inkjet printer 2 prints an image on a wide and long workpiece W by inkjet printing. The inkjet printer 2 includes an inkjet head 20 including an ink head 3 and a treatment liquid head 4, a workpiece feeder 21 that feeds the workpiece W in a workpiece feed direction F, and a carriage 22 on which the inkjet head 20 is mounted. The inkjet printer 2 is a serial printer that alternately performs an ejection operation and a feed operation of the workpiece W. In the ejection operation, the ink head 3 ejects ink and the treatment liquid head 4 ejects a treatment liquid while the carriage 22 is reciprocating in a main scanning direction H1 perpendicular to the workpiece feed direction F in a horizontal plane. In another embodiment, the inkjet printer 2 may be a line printer including the inkjet head 20 with the ink head 3 and the treatment liquid head 4 at fixed positions relative to the workpiece W being fed in the workpiece feed direction F. Note that, in the horizontal plane, the main scanning direction H1 is perpendicular to a subscanning direction H2 that is parallel to the workpiece feed direction F.

The workpiece feeder 21 includes a feed roller 211 that unwinds the workpiece W before printing, and a take-up roller 212 that winds the workpiece W after printing. The feed roller 211 is located at the upstream end in the workpiece feed direction F. The feed roller 211 is a shaft supporting a wound roll of the workpiece W before printing. The take-up roller 212 is located at the downstream end in the workpiece feed direction F. The take-up roller 212 is a shaft supporting a wound roll of the workpiece W after printing. The take-up roller 212 includes a drive such as a motor that rotates the take-up roller 212 about its axis to wind the workpiece W. The workpiece feeder 21 feeds the workpiece W in the workpiece feed direction F as the feed roller 211 rotates in response to the take-up roller 212 being rotated.

The carriage 22, which carries the ink head 3 and the treatment liquid head 4 included in the inkjet head 20, reciprocates in the main scanning direction H1 perpendicular to the workpiece feed direction F. The carriage 22 is fixed to a timing belt 24 rotatable around a carriage guide 23 that is a flat plate elongated in the main scanning direction H1. The timing belt 24 is an endless belt that is driven to rotate in the main scanning direction H1 around the carriage guide 23. As the timing belt 24 rotates in the main scanning direction H1, the carriage 22 reciprocates in the main scanning direction H1 along the carriage guide 23.

Each of the ink head 3 and the treatment liquid head 4 mounted on the carriage 22 moves relative to the workpiece W in the main scanning direction H1 and in the subscanning direction H2 when the carriage 22 reciprocates in the main scanning direction H1 with the workpiece W being fed by the workpiece feeder 21 in the workpiece feed direction F.

In the present embodiment, the ink head 3 includes multiple individual heads 31 that eject the respective colors of ink. The multiple individual heads 31 are mounted on the carriage 22. Each of the multiple individual heads 31 includes many nozzles, ink channels that guide ink into the nozzles, and a wiring board that controls an ejection operation of ink. The nozzles eject ink droplets by, for example, piezoelectric ejection using piezoelectric elements or thermal ejection using heating elements. Examples of the ink include water-based pigment ink containing a water-based solvent, a pigment, and a bonding resin. The multiple individual heads 31 are mounted on the carriage 22 in two arrays in the main scanning direction H1. Two individual heads 31 are used for each of the colors. The two individual heads 31 that eject the same color of ink are arranged on the carriage 22 in a manner displaced from each other in the main scanning direction H1 and in the subscanning direction H2. In another embodiment, a single ink head 3 may be mounted on the carriage 22.

In the present embodiment, the treatment liquid head 4 includes a pretreatment liquid head 41 and a post-treatment liquid head 42 on the carriage 22. The pretreatment liquid head 41 and the post-treatment liquid head 42 are at positions different from the position of the ink head 3 on the carriage 22 in the workpiece feed direction F parallel to the subscanning direction H2. The pretreatment liquid head 41 is located upstream from the ink head 3 on the carriage 22 in the workpiece feed direction F. In the example in FIG. 1, a single pretreatment liquid head 41 is located near one end of an array of the individual heads 31 in the ink head 3 in the main scanning direction H1. The post-treatment liquid head 42 is located downstream from the ink head 3 on the carriage 22 in the workpiece feed direction F. In the example in FIG. 1, a single post-treatment liquid head 42 is located near the other end of an array of the individual heads 31 in the ink head 3 in the main scanning direction H1. In another embodiment, the treatment liquid head 4 may include one of the pretreatment liquid head 41 or the post-treatment liquid head 42 on the carriage 22.

The pretreatment liquid head 41 includes many nozzles, pretreatment liquid channels that guide a pretreatment liquid into the nozzles, and a wiring board that controls an ejection operation of the pretreatment liquid. The nozzles eject droplets of the pretreatment liquid by, for example, piezoelectric ejection using piezoelectric elements or thermal ejection using heating elements. The pretreatment liquid head 41 ejects the pretreatment liquid onto an area of the workpiece W on which ink is yet to be ejected from the ink head 3. The pretreatment liquid is applied to the workpiece W before the ink. The pretreatment liquid is a noncolor-developing treatment liquid that comes in contact with undried ink on the workpiece W and develops no color on the workpiece W. The pretreatment liquid prevents ink from blurring on the workpiece W. Examples of the pretreatment liquid may include a treatment liquid of a solvent containing a bonding resin and a treatment liquid of a solvent containing a positively charged cationic resin.

The post-treatment liquid head 42 includes many nozzles, post-treatment liquid channels that guide a post-treatment liquid into the nozzles, and a wiring board that controls an ejection operation of the post-treatment liquid. The nozzles eject droplets of the post-treatment liquid by, for example, piezoelectric ejection using piezoelectric elements or thermal ejection using heating elements. The post-treatment liquid head 42 ejects the post-treatment liquid onto an area of the workpiece W on which ink has been ejected from the ink head 3. The post-treatment liquid is applied to the workpiece W after the ink. The post-treatment liquid is a noncolor-developing treatment liquid that comes in contact with undried ink on the workpiece W and develops no color on the workpiece W. The post-treatment liquid can improve fixation of the ink on the workpiece W. Examples of the post-treatment liquid include a silicone treatment liquid. Note that the post-treatment liquid differs from the pretreatment liquid. More specifically, the post-treatment liquid and the pretreatment liquid contain different components.

The noncolor-developing treatment liquid refers to a liquid that is not perceptible as having developed a color to the naked eye when printed on the workpiece W alone. The color includes any color with zero saturation, such as black, white, and gray. The noncolor-developing treatment liquid is basically a transparent liquid but may appear slightly white or another color. Such a faint color is not perceptible as having developed a color to the naked eye when printed on the workpiece W alone. Note that, although a type of treatment liquid printed alone on the workpiece W may cause a change such as adding gloss to the workpiece W, such a change is not referred to as developing a color.

As illustrated in FIG. 1, the inkjet printer 2 further includes a printer controller 5. The printer controller 5 is a controller that controls the ink head 3 and the treatment liquid head 4 included in the inkjet head 20. The printer controller 5 causes each of the individual heads 31 in the ink head 3 to eject ink and causes each of the pretreatment liquid head 41 and the post-treatment liquid head 42 in the treatment liquid head 4 to eject the treatment liquid based on data generated by the computer 6 (described later).

The computer 6 is a personal computer including a central processing unit (CPU), a storage area that stores a processing program, such as a hard disk drive (HDD) or a flash memory, and a random-access memory (RAM) used as a work area for the CPU. The computer 6 executes the processing program stored in the HDD or the flash memory with the CPU to function as the ink data generator that generates the ink dot data DID and also as the treatment-liquid data generator that generates the treatment liquid dot data DRD including pretreatment liquid dot data DRD1 and post-treatment liquid dot data DRD2.

The computer 6 generates the ink dot data DID used by the printer controller 5 to control the ejection of ink from the ink head 3. The computer 6 generates the treatment liquid dot data DRD used by the printer controller 5 to control the ejection of the treatment liquid from the treatment liquid head 4.

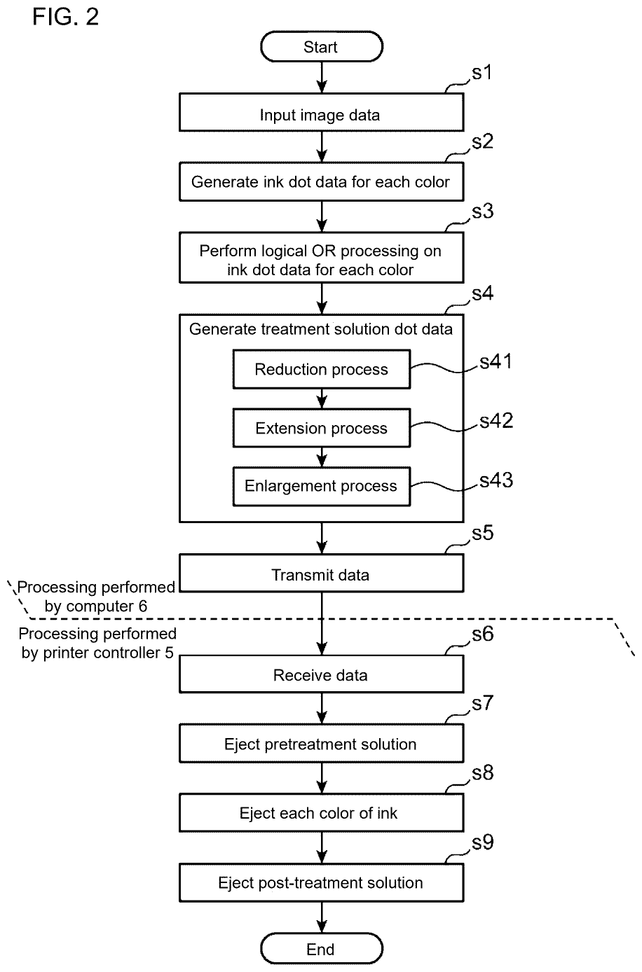

In the inkjet recording system 1 according to the present embodiment, the printer controller 5 and the computer 6 perform processing in each step included in the inkjet recording method. The processing in each step included in the inkjet recording method performed by the printer controller 5 and the computer 6 will now be described in detail with reference to FIGS. 2 to 6.

The computer 6 obtains the image data DG of an image to be printed on the workpiece W (an image data obtaining step s1). Upon obtaining the image data DG, the computer 6 generates, based on the image data DG, the ink dot data DID indicating the pattern of the ink dots ID to be formed on the workpiece W with the ink ejected from the ink head 3 (an ink data generation step s2). When the ink head 3 in the inkjet printer 2 includes the multiple individual heads 31 that eject the respective colors of ink, the computer 6 generates the ink dot data DID for each of the colors for the corresponding one of the multiple individual heads 31. The computer 6 performs a halftone process, such as dithering, on the image data DG to convert the image data DG to halftone image data that can be printed on the workpiece W by the inkjet printer 2. The computer 6 thus generates the ink dot data DID at a first resolution that can be printed by the inkjet printer 2.

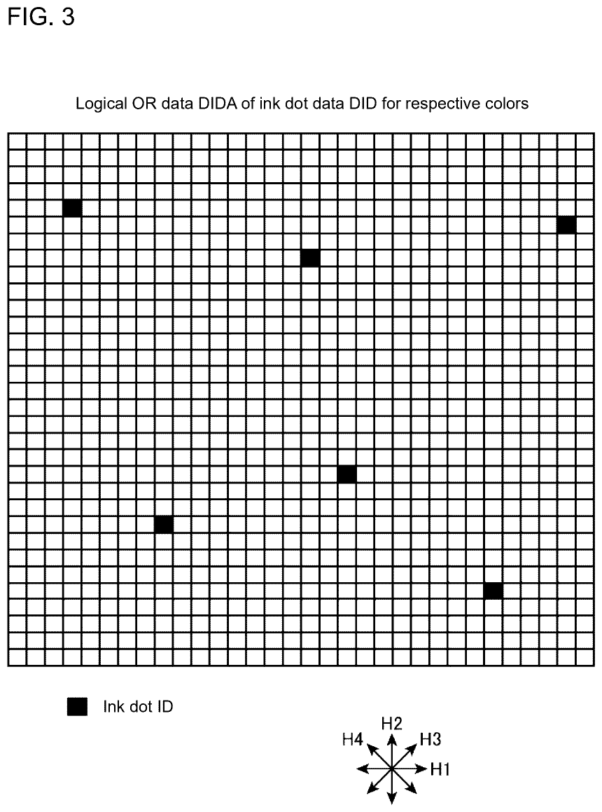

Upon generating the ink dot data DID for each of the colors, the computer 6 calculates the logical OR of the pieces of the ink dot data DID for the respective colors to obtain logical OR data DIDA illustrated in FIG. 3 (a logical OR calculation step s3). The logical OR data DIDA indicates the pattern of all the ink dots ID in the ink dot data DID for each of the colors. In the logical OR data DIDA illustrated in FIG. 3, the ink dots ID corresponding to the ink to be ejected from the ink head 3 are indicated by solid black dots, and the positions at which no ink is ejected from the ink head 3 are indicated by solid white dots. Note that, when the inkjet printer 2 includes a single ink head 3, the computer 6 skips the processing in the logical OR calculation step s3 of calculating the logical OR data DIDA.

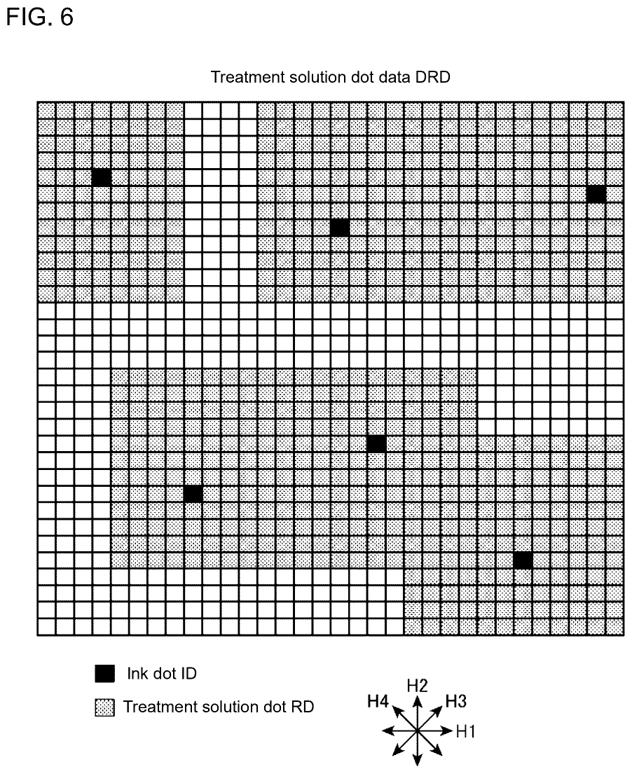

The computer 6 then generates, based on the ink dot data DID at the first resolution, the treatment liquid dot data DRD at the first resolution illustrated in FIG. 6 (a treatment-liquid data generation step s4). The treatment liquid dot data DRD indicates the pattern of treatment liquid dots RD to be formed on the workpiece W with the treatment liquid ejected from the treatment liquid head 4. In the treatment liquid dot data DRD illustrated in FIG. 6, the treatment liquid dots RD corresponding to the treatment liquid to be ejected from the treatment liquid head 4 are indicated by shaded dots, and the positions at which no treatment liquid is ejected from the treatment liquid head 4 are indicated by solid white dots. Although the treatment liquid dot data DRD indicating the pattern of the treatment liquid dots RD does not include the ink dots ID, FIG. 6 also hypothetically illustrates the positions of the ink dots ID indicated by solid black dots.

The computer 6 generates the treatment liquid dot data DRD at the first resolution including the treatment liquid dots RD at least at the same positions as the respective ink dots ID in the ink dot data DID. When the ink head 3 in the inkjet printer 2 includes the multiple individual heads 31 that eject the respective colors of ink, the computer 6 generates the treatment liquid dot data DRD at the first resolution based on the logical OR data DIDA indicating the logical OR of the pieces of the ink dot data DID for the respective colors. In this case, the computer 6 generates the treatment liquid dot data DRD at the first resolution including the treatment liquid dots RD at least at the same positions as the respective ink dots ID in the logical OR data DIDA.

Note that the computer 6 may generate the treatment liquid dot data DRD based on the image data DG. When the number of dots corresponding to the number of nozzles in the ink head 3 is the same as the number of dots corresponding to the number of nozzles in the treatment liquid head 4, the computer 6 generates the treatment liquid dot data DRD at the first resolution that is the same as the resolution of the ink dot data DID as described above. When the number of dots of the ink head 3 is not the same as the number of dots of the treatment liquid head 4, the computer 6 generates the treatment liquid dot data DRD at a resolution corresponding to the number of dots of the treatment liquid head 4. For example, when the number of dots of the treatment liquid head 4 is less than the number of dots of the ink head 3, the computer 6 generates the treatment liquid dot data DRD at a resolution lower than the first resolution of the ink dot data DID.

The computer 6 generates, as the treatment liquid dot data DRD, pretreatment liquid dot data DRD1 indicating the pattern of pretreatment liquid dots to be formed on the workpiece W with the pretreatment liquid ejected from the pretreatment liquid head 41. In the same or similar manner, the computer 6 generates, as the treatment liquid dot data DRD, post-treatment liquid dot data DRD2 indicating the pattern of post-treatment liquid dots to be formed on the workpiece W with the post-treatment liquid ejected from the post-treatment liquid head 42. In the present embodiment, the computer 6 generates the pretreatment liquid dot data DRD1 and the post-treatment liquid dot data DRD2 that are the same treatment liquid dot data DRD. The computer 6 can thus generate the treatment liquid dot data DRD with a lower processing load than when generating the pretreatment liquid dot data DRD1 and the post-treatment liquid dot data DRD2 separately.

As shown in FIG. 2, in the treatment-liquid data generation step s4 of generating the treatment liquid dot data DRD, the computer 6 performs a reduction process s41 and an extension process s42, and optionally an enlargement process s43.

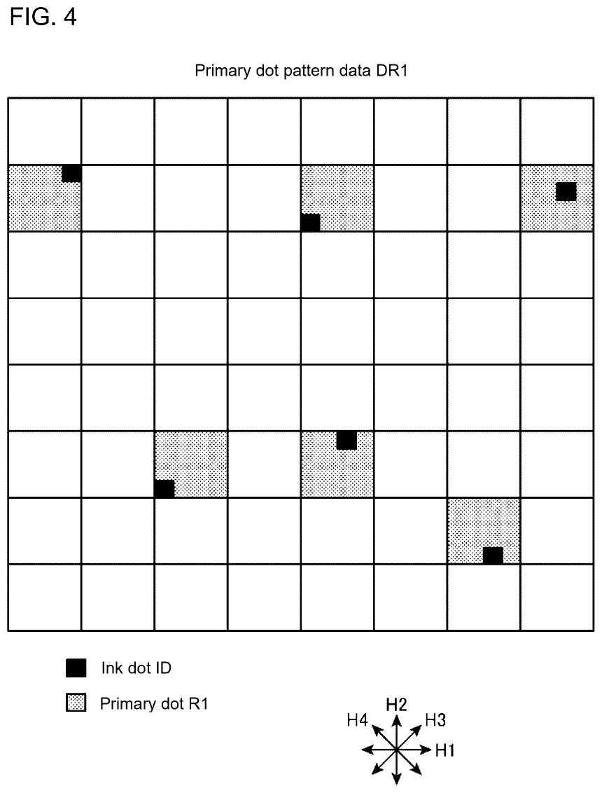

In the reduction process s41, the computer 6 converts the ink dot data DID at the first resolution or the logical OR data DIDA indicating the logical OR of the pieces of the ink dot data DID for the respective colors to primary dot pattern data DR1 illustrated in FIG. 4. The primary dot pattern data DR1 indicates the pattern of primary dots R1 at a second resolution that is lower than the first resolution. In this case, in the reduction process s41, the computer 6 reduces the pattern of the ink dots ID indicated by the ink dot data DID or the logical OR data DIDA by a reduction ratio of 1/N (N is an integer greater than or equal to 2) in the main scanning direction H1 and in the subscanning direction H2. The computer 6 thus generates the primary dot pattern data DR1 indicating the pattern of the primary dots R1 at the second resolution each including the ink dot ID.

The reduction ratio 1/N in the reduction process s41 determines the extension amount of each of the treatment liquid dots RD in the treatment liquid dot data DRD. More specifically, the reduction ratio 1/N determines the area over which the treatment liquid dot RD is spread around each of the ink dots ID in the ink dot data DID. The reduction ratio 1/N determines the processing load in the extension process s42 that is performed after the reduction process s41, and also determines the processing load for generating the treatment liquid dot data DRD. With a smaller value “N” in the reduction ratio 1/N, the treatment liquid dot RD in the treatment liquid dot data DRD is spread over a larger area around each of the ink dots ID, and such treatment liquid dot data DRD can be generated with a lower data processing load. The reduction ratio 1/N may be, for example, ¼.

Note that, although the primary dot pattern data DR1 does not include the ink dots ID, FIG. 4 also hypothetically illustrates the positions of the ink dots ID indicated by solid black dots. In the primary dot pattern data DR1 illustrated in FIG. 4, the primary dots R1 are indicated by shaded dots, and the positions with no primary dots R1 are indicated by solid white dots.

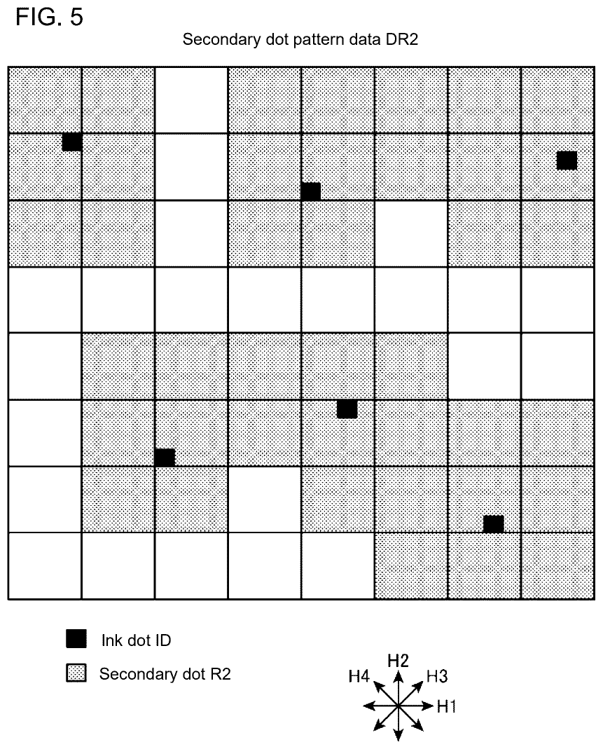

In the extension process s42 performed after the reduction process s41, as illustrated in FIG. 5, the computer 6 converts the primary dot pattern data DR1 at the second resolution to secondary dot pattern data DR2 at the second resolution indicating the pattern of secondary dots R2 by extending each of the primary dots R1 in the primary dot pattern data DR1. Although the secondary dot pattern data DR2 does not include the ink dots ID, FIG. 5 also hypothetically illustrates the positions of the ink dots ID indicated by solid black dots. In the secondary dot pattern data DR2 illustrated in FIG. 5, the secondary dots R2 are indicated by shaded dots, and the positions with no secondary dots R2 are indicated by solid white dots.

More specifically, in the extension process s42, the computer 6 extends each of the primary dots R1 in the primary dot pattern data DR1 at the second resolution by padding the primary dot R1 to a position around the primary dot R1. In other words, the computer 6 extends each of the primary dots R1 in the primary dot pattern data DR1 at the second resolution by calculating the logical OR of the position of the primary dot R1 and a position around the primary dot R1. In this case, the computer 6 extends each of the primary dots R1 in the primary dot pattern data DR1 at the second resolution to a position around the primary dot R1 to generate the secondary dot pattern data DR2 at the second resolution. The computer 6 thus generates the secondary dot pattern data DR2 at the second resolution indicating the dot pattern in which the secondary dots R2 are at the position of each of the primary dots R1 and the position around the corresponding primary dot R1 in the primary dot pattern data DR1 at the second resolution.

In the extension process s42, the computer 6 converts the primary dot pattern data DR1 at the second resolution to the secondary dot pattern data DR2 at the second resolution by extending each of the primary dots R1 in the primary dot pattern data DR1 in at least one of the main scanning direction H1 or the subscanning direction H2. When the computer 6 extends each of the primary dots R1 in the primary dot pattern data DR1 in the main scanning direction H1, the computer 6 can generate the secondary dot pattern data DR2 indicating the dot pattern in which the secondary dots R2 are at the position of each of the primary dots R1 and the positions adjacent to the corresponding primary dot R1 on opposite sides in the main scanning direction H1. In the same or similar manner, when the computer 6 extends each of the primary dots R1 in the primary dot pattern data DR1 in the subscanning direction H2, the computer 6 can generate the secondary dot pattern data DR2 indicating the dot pattern in which the secondary dots R2 are at the position of each of the primary dots R1 and the positions adjacent to the corresponding primary dot R1 on opposite sides in the subscanning direction H2. When the computer 6 extends each of the primary dots R1 in the primary dot pattern data DR1 in the main scanning direction H1 and in the subscanning direction H2, the computer 6 can generate the secondary dot pattern data DR2 indicating the dot pattern in which the secondary dots R2 are at the position of each of the primary dots R1, the positions adjacent to the corresponding primary dot R1 on opposite sides in the main scanning direction H1, and the positions adjacent to the corresponding primary dot R1 on opposite sides in the subscanning direction H2.

In the extension process s42, the computer 6 may convert the primary dot pattern data DR1 at the second resolution to the secondary dot pattern data DR2 at the second resolution by extending each of the primary dots R1 in the primary dot pattern data DR1 in the main scanning direction H1 and the subscanning direction H2, and in a first diagonal direction H3 and a second diagonal direction H4 each intersecting with both the main scanning direction H1 and the subscanning direction H2. The computer 6 can thus generate the secondary dot pattern data DR2 indicating the dot pattern in which the secondary dots R2 are at the position of the each of the primary dots R1 in the primary dot pattern data DR1, the positions adjacent to the corresponding primary dot R1 on opposite sides in the main scanning direction H1, the positions adjacent to the corresponding primary dot R1 on opposite sides in the subscanning direction H2, the positions adjacent to the corresponding primary dot R1 on opposite sides in the first diagonal direction H3, and the positions adjacent to the corresponding primary dot R1 on opposite sides in the second diagonal direction H4. Note that each of the first diagonal direction H3 and the second diagonal direction H4 intersects with both the main scanning direction H1 and the subscanning direction H2 at, for example, 45 degrees and is not parallel to the main scanning direction H1 or the subscanning direction H2.

When the number of dots of the ink head 3 corresponds to the first resolution of the ink dot data DID and the number of dots of the treatment liquid head 4 corresponds to the second resolution lower than the first resolution, the computer 6 identifies the secondary dot pattern data DR2 at the second resolution generated in the extension process s42 as the treatment liquid dot data DRD.

In contrast, when the number of dots of the ink head 3 is the same as the number of dots of the treatment liquid head 4, the computer 6 performs, after the extension process s42, the enlargement process s43 on the secondary dot pattern data DR2 at the second resolution to generate the treatment liquid dot data DRD at the first resolution illustrated in FIG. 6. In this case, the computer 6 enlarges the pattern of the secondary dots R2 indicated by the secondary dot pattern data DR2 at the second resolution by an enlargement ratio that is the inverse of the reduction ratio used in the reduction process s41 multiplied by N (N is an integer greater than or equal to 1) in each of the main scanning direction H1 and the subscanning direction H2. The computer 6 thus generates the treatment liquid dot data DRD at the first resolution, which is the same as the resolution of the ink dot data DID. The computer 6 can thus generate the treatment liquid dot data DRD at the first resolution indicating the dot pattern in which the treatment liquid dots RD are at the position of each of the ink dots ID in the ink dot data DID and the positions in a large area around the ink dot ID.

As described above, the computer 6 performs the reduction process s41 on the ink dot data DID at the first resolution or the logical OR data DIDA indicating the logical OR of the pieces of the ink dot data DID for the respective colors to convert such data to the primary dot pattern data DR1 at the second resolution, then performs the extension process s42 on the primary dot pattern data DR1 to convert the primary dot pattern data DR1 to the secondary dot pattern data DR2 at the second resolution, and then performs the enlargement process s43 on the secondary dot pattern data DR2 to generate the treatment liquid dot data DRD at the first resolution. In this manner, the computer 6 can generate the treatment liquid dot data DRD with a lower processing load than when the computer 6 generates the treatment liquid dot data DRD by directly performing the extension process s42 on the ink dot data DID without performing the reduction process s41 of lowering the resolution of the ink dot data DID. This also allows efficient generation of the treatment liquid dot data DRD in which the treatment liquid dots RD are spread over a large area around each of the ink dots ID in the ink dot data DID.

As shown in FIG. 2, after generating the ink dot data DID for each of the colors and the treatment liquid dot data DRD, the computer 6 transmits the generated ink dot data DID for each of the colors and the treatment liquid dot data DRD to the inkjet printer 2 (a data transmission step s5).

When the inkjet printer 2 receives the ink dot data DID for each of the colors and the treatment liquid dot data DRD (a data reception step s6), the printer controller 5 controls the ink head 3 and the treatment liquid head 4 included in the inkjet head 20 to perform ejection processes including a pretreatment liquid ejection step s7, a color ink ejection step s8, and a post-treatment liquid ejection step s9 in this order.

In the pretreatment liquid ejection step s7, the printer controller 5 causes the pretreatment liquid head 41 to eject the pretreatment liquid based on the treatment liquid dot data DRD as the pretreatment liquid dot data DRD1. This forms the pattern of the pretreatment liquid dots on the workpiece W based on the pattern of the treatment liquid dots RD in the treatment liquid dot data DRD.

In the color ink ejection step s8 after the pretreatment liquid ejection step s7, the printer controller 5 causes each of the multiple individual heads 31 in the ink head 3 to eject ink based on the ink dot data DID for each of the colors. This forms the pattern of ink dots on the workpiece W based on the pattern of the ink dots ID in the ink dot data DID for each of the colors, allowing an image to be printed on the workpiece W.

On the workpiece W, the pattern of the pretreatment liquid dots based on the treatment liquid dot data DRD has been formed before the pattern of ink dots is formed. As described above, the treatment liquid dot data DRD indicates the pattern in which the treatment liquid dots RD are at the position of each of the ink dots ID in the ink dot data DID and the positions in a large area around the ink dot ID. Thus, on the workpiece W, the pretreatment liquid dots have been formed, before the pattern of ink dots is formed, at the positions at which the ink dots are to be formed and over large areas around the ink dots. This reliably prevents ink from blurring on the workpiece W when the ink dots are formed on the workpiece W, with the pretreatment liquid dots formed at the ink dots and over large areas around the ink dots.

In the post-treatment liquid ejection step s9 after the color ink ejection step s8, the printer controller 5 causes the post-treatment liquid head 42 to eject the post-treatment liquid based on the treatment liquid dot data DRD as the post-treatment liquid dot data DRD2. This forms the pattern of the post-treatment liquid dots on the workpiece W based on the pattern of the treatment liquid dots RD in the treatment liquid dot data DRD.

On the workpiece W, the pattern of the post-treatment liquid dots based on the treatment liquid dot data DRD is formed after the pattern of ink dots is formed. As described above, the treatment liquid dot data DRD indicates the pattern in which the treatment liquid dots RD are at the position of each of the ink dots ID in the ink dot data DID and the positions in a large area around the ink dot ID. Thus, on the workpiece W, the post-treatment liquid dots are formed, after the pattern of ink dots is formed, at the positions at which the ink dots have been formed and over large areas around the ink dots. This reliably improves ink fixation on the workpiece W, with the post-treatment liquid dots formed at the ink dots and over large areas around the ink dots.

In the embodiment, the dots of each of the pretreatment liquid and the post-treatment liquid are formed based on the treatment liquid dot data DRD at the positions at which the ink dots are to be formed and over large areas around the ink dots. Such an embodiment is particularly effective for repeat printing in which the same pattern of ink dots is repeated in the main scanning direction H1 and in the subscanning direction H2.

In the present embodiment, as described above, the computer 6 generates the treatment liquid dot data DRD corresponding to the ink dot data DID by performing the reduction process s41 and the extension process s42 in sequence, and optionally the enlargement process s43. The computer 6 can thus generate the treatment liquid dot data DRD corresponding to the ink dot data DID with a lower processing load. This thus can shorten the processing time for generating the treatment liquid dot data DRD.

### REFERENCE SIGNS

1 inkjet recording system
2 inkjet printer
20 inkjet head
3 ink head
31 individual head
4 treatment liquid head
41 pretreatment liquid head
42 post-treatment liquid head
5 printer controller (controller)
6 computer (ink data generator, treatment-liquid data generator)
DG image data
DID ink dot data
DRD treatment liquid dot data
DRD1 pretreatment liquid dot data
DRD2 post-treatment liquid dot data
W workpiece (recording material)

1. An inkjet recording system, comprising:
an inkjet head including an ink head configured to eject ink onto a recording material, and a treatment liquid head configured to eject a treatment liquid to come in contact with the ink on the recording material;
an ink data generator configured to generate ink dot data based on image data of an image to be recorded on the recording material, the ink dot data indicating a pattern of ink dots to be formed on the recording material with the ink ejected from the ink head;
a treatment-liquid data generator configured to generate treatment liquid dot data indicating a pattern of treatment liquid dots to be formed on the recording material with the treatment liquid ejected from the treatment liquid head; and
a controller configured to control the inkjet head to cause the ink head to eject the ink based on the ink dot data and to cause the treatment liquid head to eject the treatment liquid based on the treatment liquid dot data,
wherein the treatment-liquid data generator is configured to generate the treatment liquid dot data by performing a reduction process and an extension process, the reduction process is a process of converting the ink dot data at a first resolution to data of a primary dot pattern at a second resolution being lower than the first resolution, and the extension process is a process of converting the data of the primary dot pattern to data of a secondary dot pattern by extending each of dots in the primary dot pattern.

2. The inkjet recording system according to claim 1, wherein
the treatment-liquid data generator is configured to generate the treatment liquid dot data at the first resolution by performing an enlargement process on the data of the secondary dot pattern after performing the extension process.

3. The inkjet recording system according to claim 1, wherein
the ink head includes a plurality of individual heads each configured to eject the ink of a corresponding color of a plurality of colors,
the ink data generator is configured to generate the ink dot data corresponding to each of the plurality of individual heads, and
in the reduction process, the treatment-liquid data generator is configured to convert logical OR data to the data of the primary dot pattern, and the logical OR data indicates a logical OR of pieces of the ink dot data corresponding to the plurality of respective individual heads.

4. The inkjet recording system according to claim 1, wherein
the treatment liquid head is movable relative to the recording material in a main scanning direction and in a subscanning direction perpendicular to the main scanning direction, and
in the extension process, the treatment-liquid data generator is configured to convert the data of the primary dot pattern to the data of the secondary dot pattern by extending each of the dots in the primary dot pattern in at least one of the main scanning direction or the subscanning direction.

5. The inkjet recording system according to claim 1, wherein
the treatment liquid head is movable relative to the recording material in a main scanning direction and in a subscanning direction perpendicular to the main scanning direction, and
in the extension process, the treatment-liquid data generator is configured to convert the data of the primary dot pattern to the data of the secondary dot pattern by extending each of the dots in the primary dot pattern in the main scanning direction, the subscanning direction, a first diagonal direction, and a second diagonal direction, and each of the first diagonal direction and the second diagonal direction intersects with the main scanning direction and with the subscanning direction.

6. The inkjet recording system according to claim 1, wherein
the treatment liquid head includes a pretreatment liquid head configured to eject a pretreatment liquid as the treatment liquid to cause the pretreatment liquid to be applied to the recording material before the ink,
the treatment-liquid data generator is configured to generate, as the treatment liquid dot data, pretreatment liquid dot data indicating a pattern of pretreatment liquid dots to be formed on the recording material with the pretreatment liquid ejected from the pretreatment liquid head, and
the controller is configured to cause the ink head to eject the ink based on the ink dot data after causing the pretreatment liquid head to eject the pretreatment liquid based on the pretreatment liquid dot data.

7. The inkjet recording system according to claim 1, wherein
the treatment liquid head includes a post-treatment liquid head configured to eject a post-treatment liquid as the treatment liquid to cause the post-treatment liquid to be applied to the recording material after the ink,
the treatment-liquid data generator is configured to generate, as the treatment liquid dot data, post-treatment liquid dot data indicating a pattern of post-treatment liquid dots to be formed on the recording material with the post-treatment liquid ejected from the post-treatment liquid head, and
the controller is configured to cause the post-treatment liquid head to eject the post-treatment liquid based on the post-treatment liquid dot data after causing the ink head to eject the ink based on the ink dot data.

8. The inkjet recording system according to claim 1, wherein
the recording material is a fabric member comprising fabric.

9. An inkjet recording method for recording an image on a recording material using an inkjet head including an ink head configured to eject ink onto a recording material and a treatment liquid head configured to eject a treatment liquid to come in contact with the ink on the recording material, the method comprising:
generating ink dot data based on image data of the image to be recorded on the recording material, the ink dot data indicating a pattern of ink dots to be formed on the recording material with the ink ejected from the ink head;
generating treatment liquid dot data indicating a pattern of treatment liquid dots to be formed on the recording material with the treatment liquid ejected from the treatment liquid head;
causing the ink head to eject the ink based on the ink dot data; and
causing the treatment liquid head to eject the treatment liquid based on the treatment liquid dot data,
wherein generating the treatment liquid dot data includes performing a reduction process and an extension process, the reduction process is a process of converting the ink dot data at a first resolution to data of a primary dot pattern at a second resolution being lower than the first resolution, and the extension process is a process of converting the data of the primary dot pattern to data of a secondary dot pattern by extending each of dots in the primary dot pattern.
